(19) United States
(12) Patent Application Publication
(10) Pub. No.: US 2005/0133956 A1
(43) Pub. Date: Jun. 23, 2005

(54) Resin formulation

(76) Inventor: Walter A. Beauchamp, Sammamish, WA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/013,113

(22) Filed: Dec. 15, 2004

Related U.S. Application Data
(60) Provisional application No. 60/532,650, filed on Dec. 23, 2003.

(51) Int. Cl. B29C 70/48; B29C 71/02

(52) U.S. Cl. 264/236; 264/257; 528/310

(57) ABSTRACT

An RTM formulation for advanced composite resins using low molecular weight alcohol, and methods for using such resins, are disclosed. In one embodiment, polyimide resin is solvated with a low molecular weight alcohol such as ethanol instead of N-methyl-2-pyrrolidone. Advantageously, the present invention allows for quicker, safer, and more efficient RTM processing to manufacture quality composites by decreasing process cycle time, toxic exposure, and waste issues, while improving seal integrity and part quality.

### CROSS-REFERENCE TO RELATED APPLICATIONS

This application claims the benefit of U.S. Provisional Application No. 60/532,650, filed Dec. 23, 2003, which is incorporated by reference in its entirety for all purposes.

### TECHNICAL FIELD

The present invention relates generally to a resin formulation and method of use, and more particularly, to a resin transfer molding (RTM) thermoplastic resin formulated or solvated in a low molecular weight alcohol for process, safety, and health improvements.

### BACKGROUND

Resin transfer molding (RTM) is promising as a process to replace complicated built-up metal assemblies with fiber-reinforced resin composite alternatives. In one example, RTM involves a process by which a resin is pumped at low viscosities and low pressures into a closed mold die set containing a preform of dry fabric to infuse resin into the preform and to make a fiber-reinforced composite part after curing. Advantageously, the RTM process can be used to produce composite parts that are complex in shape but at lower cost.

Currently, many advanced composite resins, such as those comprising polyimide, are solvated in N-methyl-2-pyrrolidone (NMP), which is now considered a toxic material. To obtain an adequate viscosity for injection in an RTM process, the amount of NMP used is relatively large, as much as 30% by weight. When curing the resin to remove the NMP solvent, seals for the mold die set are exposed for a considerable time to higher temperatures of about 225° C.-300° C. to evaporate the excess NMP, which has a relatively high boiling point of about 204° C. Accordingly, current resin formulations tend to degrade mold seals, increase process cycle time, and increase toxic exposure and waste.

As a result, there is a need for an improved resin formulation and methods to use such resins to improve seal life/integrity, decrease process cycle time, and decrease toxic exposure and hazardous waste.

### SUMMARY

An RTM formulation for advanced composite resins using low molecular weight alcohol, and methods for using such resins, are disclosed. Advantageously, the present invention allows for quicker, safer, and more efficient RTM processing to manufacture quality composites by decreasing process cycle time, toxic exposure, and waste issues, while improving seal integrity and part quality.

In accordance with one embodiment of the present invention, a resin transfer molding (RTM) resin is provided, the resin including monomer reactants solvated in an alcohol. In one example, the alcohol is a low molecular weight alcohol.

In accordance with another embodiment of the present invention, a method of fabricating a resin transfer molding (RTM) composite is provided, the method comprising placing a preform of reinforcing fibers in a cavity of RTM tooling, injecting a resin solvated in an alcohol into the cavity to wet the preform, and curing the resin solvated in the alcohol.

In accordance with yet another embodiment of the present invention, a method of protecting seals in a resin transfer molding (RTM) tool is provided, the method comprising providing an RTM tool with a seal, mixing a resin with a resin carrier which can be cured at a temperature lower than a temperature that degrades the seal, injecting the mixed resin into the tool, and curing the mixed resin below a temperature that degrades the seal.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a flowchart of a method to fabricate composites and/or preserve RTM tool seals by using a resin solvated in alcohol in accordance with an embodiment of the present invention.

FIG. 2 shows a graph of volatiles generated during an RTM process in accordance with an embodiment of the present invention.

Embodiments of the present invention and their advantages are best understood by referring to the detailed description that follows. Like reference numerals are used to identify like elements illustrated in one or more of the figures.

### DETAILED DESCRIPTION

A preferred resin transfer molding (RTM) formulation for an advanced composite resin replaces N-methyl-2-pyrrolidone (NMP) with ethanol (EtOH), propanol, isopropanol, another low molecular weight (LMW) alkyl alcohol, or mixtures thereof. In one embodiment, polyimide resin is solvated with the LMW alcohol. In one example, with no intent to limit the invention, a polyimide resin, such as the AVIMID® K3B resin available from Cytec Engineered Materials Inc. of Anaheim, Calif., is solvated in 100% ethanol at about 64% cured resin solids by weight.

“Solvated” is defined in this document as being mixed with a solvent, such as an alcohol (e.g., ethanol), used to dissolve or to disperse the resin (or its resin precursors). The resin or its monomer reactants may not actually dissolve in the alcohol, so the alcohol may be described in one embodiment as a resin carrier or a carrier solvent. The solvent may also include additional additives, if desired, in some formulations.

The resins are readily dispersed in a LMW alcohol and stay dispersed during the cure cycle. A LMW alcohol will usually lower the resin viscosity, boil at a lower temperature than NMP (e.g., ethanol has a higher vapor pressure), and be less toxic than NMP. A LMW alcohol also evolves more readily from the resin, reducing the likelihood of entrapping volatiles that can lead to void formation in the composite, and thus reducing the likelihood of component defects. A lower boiling point and earlier evolution of the LMW alcohol also improves seal integrity by lowering or eliminating exposure of a seal to degrading temperatures. Thus, a LMW alcohol allows for quicker, safer, and more efficient RTM processing to manufacture quality composites.

Advantageously, composites made from alcohol-solvated resin have properties comparable to or essentially the same as composites made using formulations of conventional resins in NMP or other commonly used solvents. Testing indicates that there is no substantial difference in resin behavior (e.g., glass transition temperature T_{g}, melting temperature Tₘ, and melt viscosity) from a change in the solvent system.

In one embodiment, ethanol may be used as a preferred solvent because the curing resins usually release ethanol as a condensation byproduct when the protecting groups are released from the monomer reactants. An ethanol-solvated resin has a lower viscosity than the corresponding NMP-solvated resin with a similar concentration of solvent. Therefore, the ethanol-solvated resin “wets” the RTM preform more readily, and the likelihood of resin “starvation” is reduced. The ethanol evolves from the resin earlier in the process cycle than NMP at about 130° C.-150° C. In other words, the mixture of polyimide resin solvated in ethanol emits volatiles at lower processing temperatures than when using NMP. At these lower temperatures, the seals retain their integrity more readily. Substantially all of the ethanol will evolve by about 175° C.-180° C. while NMP requires heating to about 225° C.-300° C. or even higher.

With the use of ethanol, the formulations are not true solutions but may be opaque dispersions or colloidal suspensions, similar to the monomer reactants or resin precursors in NMP. The ethanol-based mixtures show some tendency to settle (they develop some vertical color thickness separation) especially at lower resin content. Mixtures that settle, however, are easily remixed.

The base polymer properties, used as typical certification values prior to shipping, are not affected by the resin carrier/carrier solvent change. Several trials to determine a revised process cycle have been undertaken with promising results using an existing/modified tool. The modification performed on the tool allowed for more robust sealing and increased seal material robustness to ensure integrity during the process. Alternate mandrel materials also provided increased “venting” in order to draw the volatiles more efficiently. In addition, the tooling had the capability to provide the required compaction forces necessary to achieve acceptable quality components by providing the capability to change the part cavity volume by about 30%.

The trials started with approximately 150 ml of AVIMID® K3B resin solvated with approximately 60 ml of ethanol, and about 20 ml of volatiles were collected during processing, which correlates to the expected amount, assuming typical and process equipment losses. The volatiles emerged relatively early in the process cycle and at much lower temperatures than the NMP-solvated resin, and the increase in seal material performance provided not only better performance, but increased worker safety.

The process cycle (largely the curing time) can be reduced by approximately 15% in one example. The current process using AVIMID® K3B resin solvated in NMP requires heating for five (5) hours at 650° F. prior to pressure application to allow crystallized NMP to evolve. Such a heating operation may be eliminated with the present invention. Thus, the present invention provides a faster and cooler process which saves energy. The ability to fabricate flight quality hardware is also increased due to the process benefits of early volatile evolution and subsequent removal while the tooling seals are at their highest integrity levels. The lower viscosity of the mixture also helps to inject the resin and in “wetting-out” the preform.

The reduction in factory operating costs is realized by reducing hazardous waste (and thus reducing the need for waste elimination or removal) and worker exposure issues. Additional cost reductions are likely to be realized in resin and prepreg material supplies by reducing the costs associated with hazardous material storage, use, transport, and disposal.

Increased component quality for RTM manufacture is realized from better seal integrity during the earlier evolution/loss of volatiles. The process should also reduce part rejection rates over those experienced with conventional formulations using NMP because of the reduction in void formation from volatiles entrapment. In other words, the void content percentage by volume of voids in the composite is advantageously lowered.

RTM processing is described in greater detail in U.S. Pat. Nos. 5,851,336 and 6,560,843, which are incorporated by reference for all purposes. The present invention may also be suitable for vacuum-assisted RTM processes, such as the Seemann Composites Resin Infusion Molding Process (SCRIMP™) described in U.S. Pat. Nos. 4,902,215 and 6,773,655, which are incorporated by reference for all purposes, or the Boeing Company's Controlled Atmospheric Pressure Resin Infusion (CAPRI) process described in PCT WO 03/101708, which is incorporated by reference for all purposes.

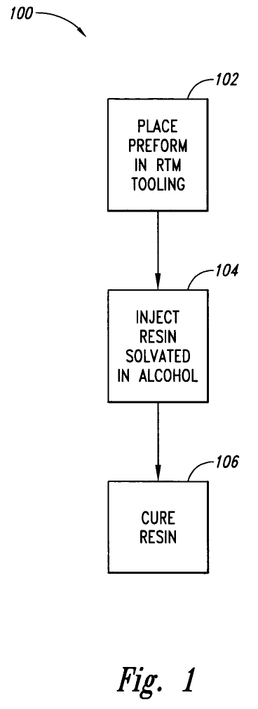

FIG. 1 shows a flowchart of a method 100 to fabricate composites and/or to preserve RTM tool seals, using a resin solvated in alcohol in accordance with an embodiment of the present invention.

In operation 102, a preform, of dry fabric in one example, is placed in a mold die set or other RTM tooling that will be used to form the final part. Typical methods may be used to build the tooling and a mold-release coating, such as silicon may be applied to the contact surfaces of the tooling to allow for easy removal of the finished part. The tooling should be made of material that can withstand moderate pressures and high temperatures.

In operation 104, a resin solvated in an alcohol is pumped at low viscosities and low pressures into the RTM tooling to infuse resin into the preform. In operation 106, the RTM tooling, preform, and resin are cured to make a fiber-reinforced composite part. In one example, curing operation 106 may be performed at temperatures between about 175° C. and about 180° C. for less than 5 hours and between about 3-4 hours in a further example.

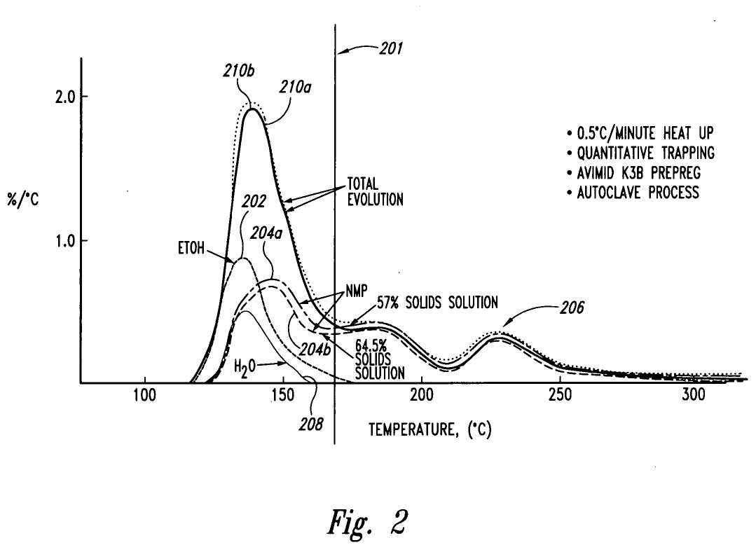

FIG. 2 shows a graph of volatiles generated during an RTM process in accordance with an embodiment of the present invention. Temperature in degrees Celsius is graphed along the X-axis and percentage per degrees Celsius (a normalized scale that shows percentage volatile molecules or compounds evolved per degree Celsius) is graphed along the Y-axis. A line 201 illustrates a region where the onset of elastomeric seal degradation occurs. Advantageously, ethanol volatiles evolve during an initial portion of the process cycle, as shown by curve 202, which is prior to the region where the onset of elastomeric seal degradation occurs. Ethanol volatiles also evolve earlier than NMP, as shown by a comparison of curve 202 to curves 204a and 204b, which represent NMP volatiles from NMP-solvated resin solutions of 57% and 64.5% by weight solids, respectively. NMP is still evolving after elastomeric seal degradation onset, as shown by second peak 206 observed at approximately 225° C. (or approximately 437° F.), well beyond seal degradation onset. Curves 202 and 208 illustrate the evolution of ethanol and water, respectively. Curves 210a and 210b illustrate the summation of all evolved components.

Embodiments described above illustrate but do not limit the invention. It should also be understood that numerous modifications and variations are possible in accordance with the principles of the present invention. Accordingly, the scope of the invention is defined only by the following claims.

1. A resin transfer molding (RTM) resin including monomer reactants solvated in at least one alcohol.

2. The RTM resin of claim 1, wherein the monomer reactants cure to form an imide group.

3. The RTM resin of claim 1, wherein the alcohol has higher volatility than N-methylpyrrolidone (NMP).

4. The RTM resin of claim 1, wherein the alcohol includes a low molecular weight alcohol.

5. The RTM resin of claim 1, wherein the alcohol includes an alkyl alcohol.

6. The RTM resin of claim 1, wherein the alcohol is selected from the group consisting of ethanol, propanol, isopropanol, and mixtures thereof.

7. The RTM resin of claim 1, wherein the alcohol is 100% ethanol and the monomer reactants provide at least 64% cured resin solids by weight.

8. A method of fabricating a resin transfer molding (RTM) composite, comprising:
placing a preform of reinforcing fibers in a cavity of RTM tooling;
injecting a resin solvated in an alcohol into the cavity to wet the preform; and curing the resin solvated in the alcohol.

9. The method of claim 8, wherein the curing operation is performed at temperatures between about 175° C. and about 180° C.

10. The method of claim 8, wherein the curing operation is performed at temperatures between about 130° C. and about 150° C. for between about 3 hours and about 4 hours.

11. The method of claim 8, wherein the curing operation produces ethanol as a by-product.

12. The method of claim 8, wherein the resin is cured to form a polyimide polymer.

13. The method of claim 8, wherein the alcohol has higher volatility than N-methylpyrrolidone (NMP) and includes an alkyl alcohol.

14. A method of fabricating a resin transfer molding (RTM) composite, comprising:
placing a preform of reinforcing fibers in a cavity of RTM tooling including a seal;
injecting a polyimide polymer resin solvated in ethanol into the cavity to wet the preform; and
curing the resin solvated in ethanol at a temperature of about 175° C.

15. A method of protecting seals in a resin transfer molding (RTM) tool, comprising:
providing an RTM tool with a seal;
mixing a resin with a resin carrier which can be cured at a temperature lower than a temperature that degrades the seal;
injecting the mixed resin into the tool; and
curing the mixed resin below a temperature that degrades the seal.

16. The method of claim 15, wherein the curing operation is performed at temperatures between about 175° C. and about 180° C.

17. The method of claim 15, wherein the curing operation is performed at temperatures between about 130° C. and about 150° C. for between about 3 hours and about 4 hours.

18. The method of claim 15, wherein the curing operation produces ethanol as a by-product.

19. The method of claim 15, wherein the resin is cured to form a polyimide polymer.

20. The method of claim 15, wherein the resin carrier has higher volatility than N-methylpyrrolidone (NMP) and includes an alkyl alcohol.
